(19) United States
(12) Patent Application Publication
(10) Pub. No.: US 2011/0117283 A1
(43) Pub. Date: May 19, 2011

(54) SPRAY COATING SYSTEM

(76) Inventors: Chia-Hao HSUEH, Hsinchu City (TW); Yuan-Chun CHAO, Hsinchu City (TW); Kuo-Hsing TENG, Beipu Township (TW); Chao-Chen CHEN, Hsinchu City (TW)

(21) Appl. No.: 12/618,464

(22) Filed: Nov. 13, 2009

(51) Int. Cl. B05D 1/02; B05C 9/08

(52) U.S. Cl. 427/425; 118/58

(57) ABSTRACT

A spray coating system is provided. The spray coating system includes a spin support for supporting and spinning the substrate; a sprayer for applying a material to an upper surface of the substrate; a cup surrounding a lateral and lower region of the spin support, wherein an opening is located in an upper central region of the cup; an air supply mechanism for supplying air flows to a back surface of the substrate to prevent the material from adhering thereto, and an exhaust zone disposed below a slanted surface of the cup for exhausting the air flow and material.

### BACKGROUND OF THE INVENTION

1. Field of the Invention

The present invention relates to a spray coating system, and in particular relates to a spray coating system including an air flow that prevents substrate contamination.

2. Description of the Related Art

The production of semiconductor devices, such as semiconductor wafers, semiconductor substrates, flat panel displays, data discs and other similar articles, generally require at least one step in which a uniform layered coating must be applied across a surface of the device. For instance, the production of integrated circuits frequently involves the application of a photo-resist uniform coating on a silicon wafer or substrate. A common prior art technique for applying the photo-resist uniform coating involves spraying the wafer with a photo-resist and then spinning the wafer. The spinning action of the wafer produces centrifugal forces which spread the photo-resist thereon.

Conventional spray coating systems includes a suction type spin support for supporting and spinning a substrate substantially in horizontal posture, a spray nozzle for supplying a coating solution to the substrate from above, a scatter preventive cup surrounding lateral and lower regions of the spin support for preventing scattering of the coating solution, and a rinse apparatus for providing a solvent to the back surface of the substrate.

However, deficiencies exist for the conventional spray coating systems. When the coating solution is supplied from the nozzle to the upper surface of a spinning substrate, excess coating solution often overflows to the back surface of the substrate, thereby contaminating the back surface. Although, a rinse apparatus may be used to provide a washing solvent to wash and clean the contaminated back surface of the substrate, often, because of the spinning speed of the substrate, excess washing solvent is left on the back surface of the substrate after washing. Specifically, the spinning speed to uniformly spread the coating solution is not fast enough to eliminate the washing solution.

In conventional spray coating systems, due to coating solution contamination and/or washing solvent residue, the substrate must be further cleaned by manual process. Thus, yield and efficiency of the conventional spray coating process are poor.

Thus, a novel spray coating system and method are required to mitigate the previously mentioned problems.

### BRIEF SUMMARY OF INVENTION

The invention provides a spray coating system for forming a film coating on an upper surface of a substrate, comprising: a spin support for supporting and spinning the substrate; a sprayer for applying a material to an upper surface of the substrate; a cup surrounding a lateral and lower region of the spin support, wherein an opening is located in an upper central region of the cup; an air supply mechanism for supplying air flows to a back surface of the substrate to prevent the material from adhering thereto, and an exhaust zone disposed below a slanted surface of the cup for exhausting the air flow and material.

The invention provides another a spray coating system for forming a film coating on an upper surface of a substrate, comprising: a spin support for supporting and spinning the substrate; a sprayer for applying a material to an upper surface of the substrate; a cup surrounding a lateral and lower region of the support member, wherein an opening is located in an upper central region of the cup; air holes surrounding the spin support a top portion of an air path and being open toward back surface of the substrate; an air supply mechanism for supplying air flows through the air holes to a back surface of the substrate to prevent the material from adhering thereto, and an exhaust zone disposed below a slanted surface of the cup for exhausting the air flows and the material.

The invention further provides a method for spray coating a substrate, comprising providing a substrate disposed on a spin support; spraying a material to an upper surface of the substrate, and jetting air flows to a back surface of the substrate to prevent and/or remove the material from adhering to a back surface of the substrate.

### BRIEF DESCRIPTION OF DRAWINGS

The present invention can be more fully understood by reading the subsequent detailed description and examples with references made to the accompanying drawings, wherein:

FIG. 1 is a cross-sectional view showing an embodiment of a spray coating system of the invention;

FIG. 2 is a schematic view showing air flows occurring during a coating process; and

FIG. 3 is a vertical view showing a spray coating system of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

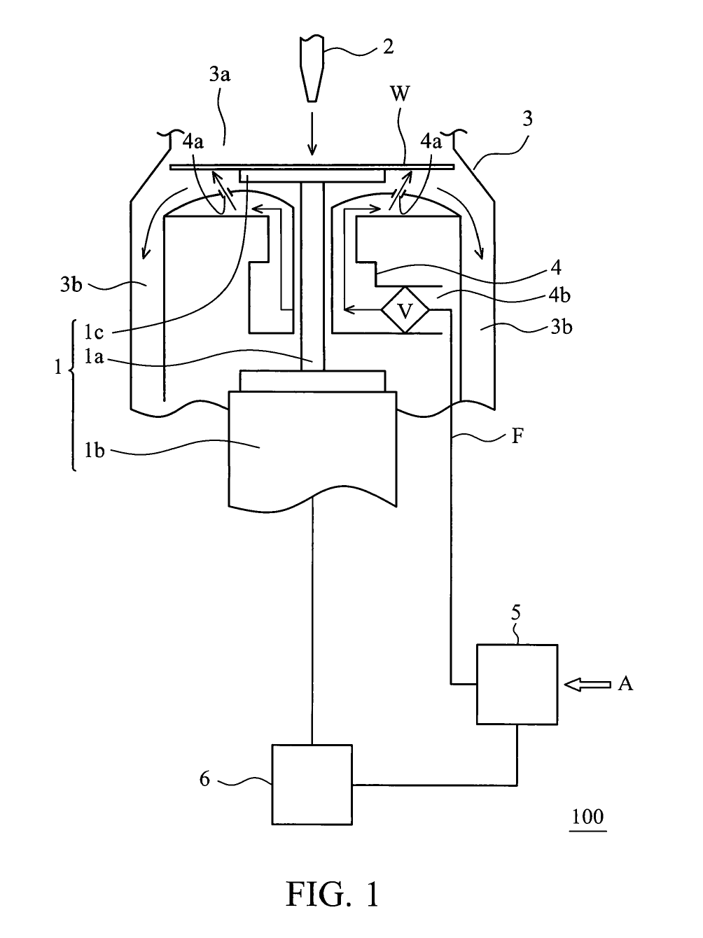

FIG. 1 illustrates an embodiment of a spray coating system according to the invention. It should be understood that the drawings herein are made in simplicity, and are utilized for illustrating associated elements related to the invention. In practical usage however, the spray coating system is more complexly structured.

FIG. 1 illustrates a spray coating system 100, typically having a spin support 1 for spinning and supporting a substrate W substantially in a horizontal position. The spin support 1 is rotatably driven by a rotary shaft 1a attached to a motor 1b, and the substrate W is supported by a support member 1c. Note that generally, the spinning speed of the spin support 1 is too low, wherein the centrifugal force is not enough to remove solution or liquid adhered to the back surface of the substrate W.

A nozzle 2 is disposed above the spin support 1 for supplying a coating material, such as a photo-resist or developer, to an upper surface of substrate W. The spin support 1 is the spin support device of this invention. The nozzle 2 is the coating material supply device (sprayer) of this invention. The substrate W can be a wafer, semiconductor substrate, glass substrate, metal substrate, or the like.

The spin support 1 is surrounded at lateral and lower regions thereof by a cup 3 to prevent scattering of the photo-resist coating material. The cup 3 includes an upper cup for defining an opening 3a in an upper central region thereof.

The cup 3 further includes an exhaust zone 3b disposed below the slanted surface of the cup 3. The exhaust zone 3b can collect the photo-resist coating material produced during a coating process and/or air flow F. Thus, the coating material and any particles of dust floating in the scatter preventive cup 3 are suctioned and exhausted along with the air flow entering through the opening 3a of cup 3.

An air path 4 surrounding the rotary shaft la includes air holes 4a. The diameter of the air holes 4a is not limited. The air holes 4a are disposed at a top portion (upper surface) of the air path 4. The air path 4 receives adjusted air flow F, and includes a pressure device V for adjusting (increasing) the pressure of the air flow F.

The air flow F supplied to the air path 4 is produced by an air flow adjusting unit 5 which takes in air flow A from inside of a cleanroom (not shown). The air flow adjusting unit 5 is controlled by a controller 6 which also controls rotation of the electric motor 1b and delivery of the photo-resist material through the nozzle 2. The air flow A or F includes, but is not limited to, atmospheric air, nitrogen, hydrogen, clean dry air (CDA), inert gas, or a mixture thereof. One skill in the art would select a proper air flow based on the spray coating material.

The air flow F is supplied to the inlet 4b of the air path 4 through a duct (not shown). The adjusted air flow F supplied to the air path 4 is delivered through the air hole 4a toward the back surface of the substrate W. In this embodiment, the controller 6 controls the pressure device V disposed in the inlet 4b to change the pressure of the air flow F.

The pressure device V, such as a pump, is disposed in the inlet 4b of the air path 4. The pressure device V can adjust and control the pressure of the air flow F supplied from the air flow adjusting unit 5 to have a suitable pressure. Generally, the pressure of the air flow F is large enough to remove the excess coating material on the back surface of the substrate W.

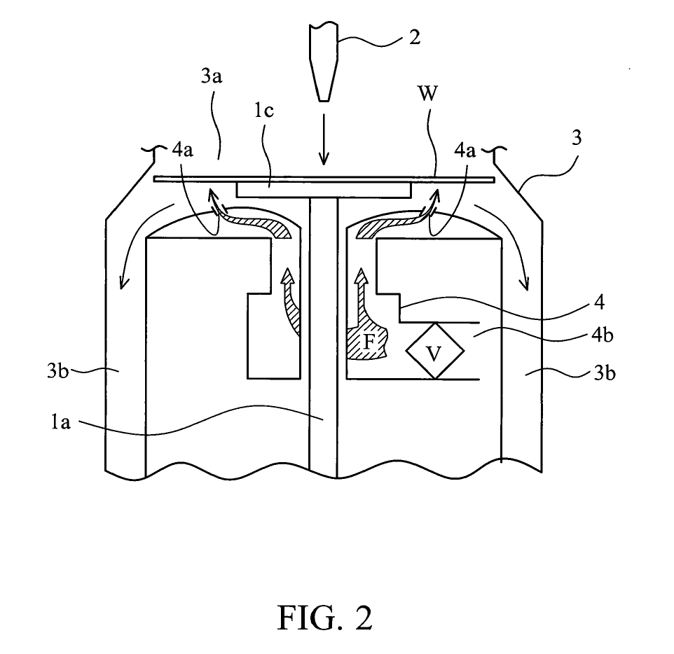

The operation of the spin coating apparatus of the invention will be described next with reference to FIG. 2. FIG. 2 is a schematic view showing air flows occurring during a coating process.

As shown in FIG. 2, air flow F is projected outward toward the back surface of substrate W through the air hole 4a formed on a top portion of the air path 4. Size of the air hole 4a is not limited.

It shall be noted that the air flow F may prevent excess coating materials from overflowing to the back surface of substrate W. Thus, coating materials produced by nozzle 2 are only located on the upper surface of the substrate W, and do not adhere to the back surface of substrate W. Thus, the spray coating system of the invention assures a non-contaminated substrate W. Then, the air flow F and excess coating materials are exhausted through the exhaust zone 3b by a suction pump (not shown).

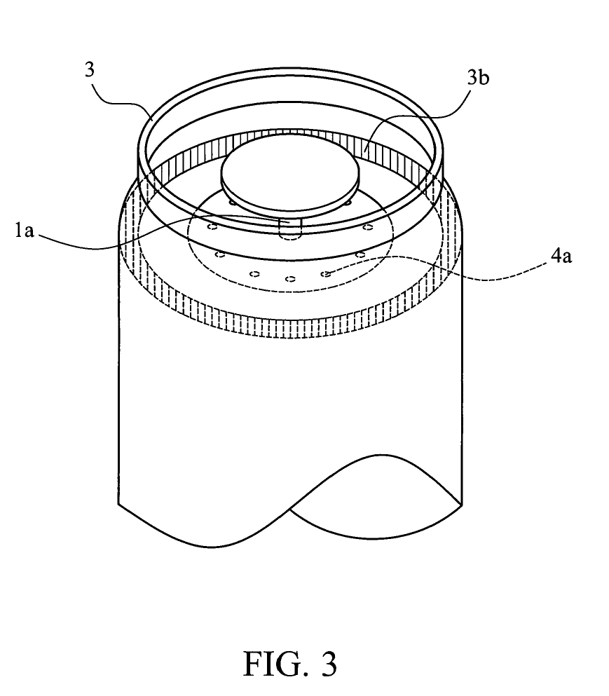

FIG. 3 is a vertical view showing a spray coating system of the invention. Referring to FIG. 3, the air holes 4a surrounds the rotary shaft la on top region of the air path 4. The arrangement of the air holes 4a includes, but is not limited to, a circular, square, oblong, triangle, polygon or other suitably shaped arrangement, and most preferably, a concentric ring arrangement. In one embodiment, the diameter of the concentric ring of the air holes 4a is not larger than the diameter of the substrate so that the air flow jetted from the air holes 4a can be supplied to a back surface of the substrate. One skilled in the art will select an appropriate air holes 4a arrangement to use, depending on applicable conditions.

The arrangement of the air holes 4a does not affect the balance of the substrate W on the spin support 1. The number of the air holes 4a is also not limited, and usually are more than one. Generally, the number of air holes is maximized to protect the back surface of the substrate W from contamination.

Additionally, the invention further provides a method for spray coating a substrate, comprising: providing a substrate disposed on a spin support; spraying a material to an upper surface of the substrate; and jetting an air flow to a back surface of the substrate to prevent the coating material from adhering thereto.

A substrate is supported and spun by a spin support during the coating process. An upper surface of the substrate is coated with one or more coating materials, such as a photoresist or developer, using a sprayer. In order to prevent excess coating material from overflowing to a back surface of the substrate, air flow is provided and projected outward toward the back surface of substrate. The air flow is uniformly projected toward the back surface of the substrate, without effecting balance of the spin support.

The air flows include, but are not limited to, atmosphere, nitrogen, hydrogen, clean dry air (CDA), inert gas, or a mixture thereof. One skill in the art would select a proper air flow based on the spray coating material. Further, the air flows have enough pressure to remove the coating materials from a sprayer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A spray coating system for forming a film coating on an upper surface of a substrate, comprising:
a spin support for supporting and spinning the substrate;
a sprayer for applying a material to an upper surface of the substrate;
a cup surrounding a lateral and lower region of the spin support, wherein an opening is located in an upper central region of the cup;
an air supply mechanism for supplying air flows to a back surface of the substrate to prevent the material from adhering thereto, and
an exhaust zone disposed below a slanted surface of the cup for exhausting the air flow and material.

2. The spray coating system as claimed in claim 1, further comprising air holes formed at a top portion of an air path and being open toward back surface of the substrate.

3. The spray coating system as claimed in claim 2, wherein the air flows are supplied thorough the air holes to the back surface of the substrate.

4. The spray coating system as claimed in claim 2, wherein the air holes surround the spin support.

5. The spray coating system as claimed in claim 2, wherein the air holes are arranged in a concentric ring.

6. The spray coating system as claimed in claim 5, wherein the diameter of the concentric ring is not larger than the diameter of the substrate.

7. The spray coating system as claimed in claim 1, wherein the air flows comprise atmospheric air, nitrogen, hydrogen, clean dry air (CDA), inert gas, or a mixture thereof.

8. The spray coating system as claimed in claim 1, further comprising a pressure device for adjusting pressure of the air flow.

9. A spray coating system for forming a film coating on an upper surface of a substrate, comprising:
a spin support for supporting and spinning the substrate;
a sprayer for applying a material to an upper surface of the substrate;
a cup surrounding a lateral and lower region of the support member, wherein an opening is located in an upper central region of the cup;
air holes surrounding the spin support at a top portion of an air path and being open toward back surface of the substrate;
an air supply mechanism for supplying air flows through the air holes to a back surface of the substrate to prevent the material from adhering thereto, and
an exhaust zone disposed below a slanted surface of the cup for exhausting the air flows and the material.

10. The spray coating system as claimed in claim 9, wherein the air holes are arranged in a concentric ring.

11. The spray coating system as claimed in claim 9, wherein the diameter of the concentric ring is not larger than the diameter of the substrate.

12. The spray coating system as claimed in claim 9, wherein the spin support comprises a rotary shaft, a motor, and a support member.

13. The spray coating system as claimed in claim 12, wherein the air path surrounds the rotary shaft.

14. The spray coating system as claimed in claim 9, further comprising a pressure device for adjusting pressure of the air flow.

15. A method for spray coating a substrate, comprising
providing a substrate disposed on a spin support;
spraying a material to an upper surface of the substrate, and
jetting air flows to a back surface of the substrate to prevent and/or remove the material from adhering to a back surface of the substrate.

16. The method as claimed in claim 15, wherein the air flow comprises atmospheric air, nitrogen, hydrogen, clean dry air (CDA), inert gas, or a mixture thereof.

17. The method as claimed in claim 15, wherein the air flow is uniformly projected outward toward a back surface of the substrate.
